(19) United States
(12) Patent Application Publication
(10) Pub. No.: US 2016/0232014 A1
(43) Pub. Date: Aug. 11, 2016

(54) Device and Method for Providing Context-Sensitive Help

(71) Applicants: Mike Burgold, München (DE); Manfred Langen, München (DE)

(72) Inventors: Mike Burgold, München (DE); Manfred Langen, München (DE)

(21) Appl. No.: 14/617,064

(22) Filed: Feb. 9, 2015

(51) Int. Cl. G06F 9/44; G06F 3/0484

(52) U.S. Cl. CPC G06F 9/4446; G06F 3/0484

(57) ABSTRACT

A device for providing context-sensitive help for a user when using a program includes a determination unit for determining continuously a contextual pattern of an actual status of the program, a retrieving unit for retrieving help information from at least one external source based on the determined contextual pattern, a comparing unit for comparing the determined contextual pattern with the retrieved help information and for selecting a subset of help information from the retrieved help information based on a result of the comparison, and a display unit for displaying continuously the subset of help information to the user, the subset of help information providing the context-sensitive help for the actual status of the program.

### FIELD

The disclosed embodiments relate to providing context-sensitive help for a user when using a program.

### BACKGROUND

When executing a program or software tool, a user might need some further information, or help information, to be able to use the program, or to improve the usage of the program. Thus, many software tools or software applications provide built-in help, which means that help information is part of the program itself and is available on a computer system of the user when executing the software tool. Such a built-in help may be provided in a context-sensitive way but is typically unchangeable and will only be updated in the course of an update of the software tool itself.

Another possibility of providing help information to a user is to provide a hyperlink to an external question and answer forum. The hyperlink may be called directly from the software tool, however, the help information is not part of the software tool but only available on an external website.

Thus, in common systems help information is only available either as built-in feature being implemented at the release date or as external help via discussion forums. In the first case, help information is available directly in the software tool but it is limited to static contents of the release date of the software tool or updates of the software tool. In the second case, the help information may be more up-to-date but is only available via external websites, which might need to be searched.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, the disclosed embodiments may provide an improved way of providing context-sensitive help when executing and using a program.

Accordingly, a device for providing context-sensitive help for a user when using a program is described. The device includes a determination unit for determining continuously a contextual pattern of an actual status of the program, a retrieving unit for retrieving help information from at least one external source based on the determined contextual pattern, a comparing unit for comparing the determined contextual pattern with the retrieved help information and for selecting a subset of help information from the retrieved help information based on a result of the comparison, and a display unit for displaying continuously the subset of help information to the user, the subset of help information providing context-sensitive help for the actual status of the program.

The device may be implemented in hardware and/or in software. If the device is implemented in hardware, the device may be configured as a computerized device, e.g., as a computer or as a processor or as a part of a system, e.g., a computer system. If the device is implemented in software, the device may be configured as a computer program product, as a function, as a routine, as a program code or as an executable object.

The respective unit, e.g., the retrieving unit, may be implemented in hardware and/or in software. If said unit is implemented in hardware, the unit may be configured as a device, e.g., as a computer or as a processor or as a part of a system, e.g., a computer system. If said unit is implemented in software, the unit may be configured as a computer program product, as a function, as a routine, as a program code or as an executable object.

The suggested device is based on the idea to provide continuously context-sensitive help within a software tool using an external source, like a discussion forum. When working with the software tool, the actions of the user are continuously observed and the external source is continuously searched for corresponding help information. Then, the corresponding help information is displayed to the user.

Thus, in contrast to other systems, the suggested device provides continuously adapted, built-in help that is not static, as the help is not fixed to the status of the implementation of the software tool.

The term context-sensitive help denotes information that is shown in a graphical form to a user. The information may include hints, tips, tricks, answers and/or corresponding questions. The information is adapted to the actual status of the program or software tool. Thus, the help information displayed to the user shows information being of possible value for the user when working with the program.

Using a program in this context means executing a program or software tool on a computing device. The software tool may have a graphical user interface. The context-sensitive help may be shown within this graphical user interface. The program may be a computer program.

The determination unit determines a contextual pattern of the used software tool. This means that information regarding the actual usage behaviour is determined and used as pattern.

The retrieving unit retrieves help information from an external source by accessing the external source and searching for help information that corresponds to the contextual pattern. The retrieving unit may communicate with the external source via an Internet connection.

The comparing unit may compare the contextual pattern and the help information from the external source in order to find a subset of the help information that may be useful or of interest to the user. For this purpose, the comparing unit may determine a matching degree between the contextual pattern and the help information.

According to an embodiment, the determination unit is adapted to determine the contextual pattern by determining statistic metadata of the program and a program history.

The statistic metadata may be data of the software tool, e.g., the program, the operating system that executes the software tool, or underlying hardware.

According to a further embodiment, the statistic metadata includes at least one of a version of the program, a configuration of the program, a used hardware, and an operating system.

Also other metadata indicating configurations or properties of any used software or hardware may be used. The metadata may be compared with metadata used in the help information of the external source.

According to a further embodiment, the program history includes at least one of activated functions, selected views, and activated files.

The program history may refer to the program history of the actual working context. This information may also be compared with the help information of the external source.

According to a further embodiment, the determination unit is adapted to determine the contextual pattern by determining an intention of the user based on the program history.

In addition to the program history, e.g., the usage behavior in the past, the determination unit may also take into account an intended usage, e.g., a usage in the future. For this purpose, the program history may be analyzed and a possible intended usage may be determined. This may be done for example by using the fact that some functions are typically used one after the other.

According to a further embodiment, the at least one external source is a dedicated forum and/or an independent forum.

A dedicated forum in this context may denote a discussion forum, or community, which is integrated into the software tool so that the dedicated forum and the software tool may work together. If the user has a question and there is no answer until now, the user may post the question directly from the software tool to the dedicated forum. In this case, metadata of the software tool are attached to the question. The question, and eventually an answer to the question, may thus be coupled with the metadata and be associated with a specific working context.

An independent forum in this context may denote a forum being not integrated into the software tool. Such an independent forum does not know and store context information (e.g., metadata) to questions and answers. In order to determine relevant help information, titles, full text as well as tags and title of the forum may be analyzed and a text pattern may be generated. This text pattern may then be associated with the contextual pattern of the software tool, for instance using a context engine. Due to the association between contextual pattern and the text pattern, the context engine may learn with each posting from the software tool into the independent forum. During such a posting, the real contextual pattern as well as the text pattern including title, text and tags are known and may be associated. Learning in this case may mean that a maximum relevance may be stored for these two patterns. Maximum relevance may denote how relevant the content may be for the user.

According to a further embodiment, the comparing unit is adapted to analyze contents of the at least one external source for generating context information of the analyzed contents.

To facilitate the comparison of the contextual pattern and the help information from the external source, the comparing unit may analyze the contents of the external source. The comparison may then be done using only some of the contents of the external source. The context information of the contents of the external source may be generated using metadata of the contents of the external source.

According to a further embodiment, the comparing unit is adapted to compare the contextual pattern and the generated context information.

Using the generated context information, e.g., a kind of context pattern, and the contextual pattern, the comparing unit may compare similar patterns.

According to a further embodiment, the comparing unit is adapted to select the subset of help information by applying a threshold to the result of the comparison.

The comparison result, e.g., the matching degree, may be compared with a threshold. The threshold may indicate whether the compared help information is relevant or not. If the threshold is set lower and the comparison result is above the threshold, than the subset will be greater but eventually also contain information that is less relevant. If the threshold is set higher and the comparison result is above the threshold, than the subset may be smaller but contain only very relevant information.

According to a further embodiment, the device further includes an evaluation unit for receiving a user input indicating an evaluation of the displayed subset of help information.

According to this embodiment, the user may not only see the context-sensitive help but may also evaluate the usefulness or relevance of the shown context-sensitive help.

According to a further embodiment, the device further includes a communication unit for receiving a question from the user and forwarding the question to the at least one external source and/or for receiving a question from the at least one external source and displaying the question to the user and/or for receiving an answer from the user to a displayed question and forwarding the answer to the at least one external source.

According to this embodiment, the user may ask questions or give answers to the question directly in the software tool. These questions and answers may be forwarded to the external source. Thus, the user may communicate with the external source via the software tool.

Any embodiment of the first aspect may be combined with any embodiment of the first aspect to obtain another embodiment of the first aspect.

According to a further aspect, a computer system is described. The computer system includes an application unit for running a program to be used by a user, a communication interface for communicating with at least one external source, and the above-described device for providing a context-sensitive help for the user when using the program by communicating with the at least one external source.

The application unit may be adapted to execute the program and to display the executed program in a graphical user interface on a display device, such as a monitor.

The communication interface may enable the computer system to communicate with one or more external sources. The communication may be done via wired or wireless communication paths, for example, a network such as the internet.

According to an embodiment, the application unit is adapted to integrate the context-sensitive help into the program.

The context-sensitive help may be displayed to the user directly within the graphical user interface of the program.

According to a further aspect, a method for providing a context-sensitive help for a user when using a program is described. The method includes the following acts: determining continuously a contextual pattern of an actual status of the program, retrieving help information from at least one external source based on the determined contextual pattern, comparing the determined contextual pattern with the retrieved help information, selecting a subset of help information from the retrieved help information based on a result of the comparison, and displaying continuously the subset of help information to the user, the subset of help information providing context-sensitive help for the actual status of the program.

According to a further aspect, a computer program product includes a program code for executing the above-described method for providing context-sensitive help for a user when using a program when run on at least one computer.

A computer program product, such as a computer program means, may be configured as a memory card, USB stick, CD-ROM, DVD or as a file that may be downloaded from a server in a network. For example, such a file may be provided by transferring the file including the computer program product from a wireless communication network.

The embodiments and features described with reference to the device and computer system of the disclosed embodiments apply mutatis mutandis to the method of the disclosed embodiments.

Further possible implementations or alternative solutions of the disclosed embodiments also encompass combinations—that are not explicitly mentioned herein—of features described above or below with regard to the embodiments. The person skilled in the art may also add individual or isolated aspects and features to the most basic form of the disclosed embodiments.

### BRIEF DESCRIPTION OF THE DRAWINGS

FIG. 1 shows a schematic block diagram of an embodiment of a device for providing context-sensitive help for a user when using a program.

FIG. 2 shows a schematic block diagram of layers used by a computer system including the device of FIG. 1.

FIG. 3 shows an embodiment of a sequence of method acts for providing context-sensitive help for a user when using a program.

In the Figures, like reference numerals designate like or functionally equivalent elements, unless otherwise indicated.

### DETAILED DESCRIPTION

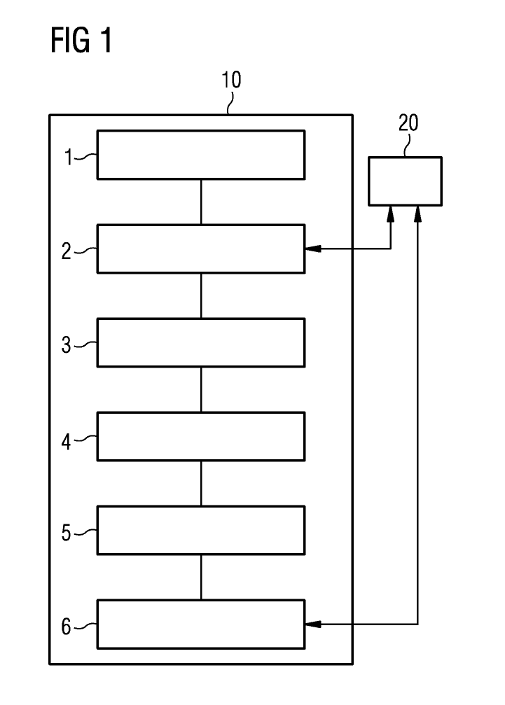

FIG. 1 illustrates a device 10 for providing context-sensitive help for a user when using a program.

The device 10 includes a determination unit 1, a retrieving unit 2, a comparing unit 3, a display unit 4, an evaluation unit 5 and a communication unit 6.

The determination unit 1 continuously determines a contextual pattern of an actual status of the program, when the program is executed and used by the user.

The retrieving unit 2 retrieves help information from at least one external source 20 based on the determined contextual pattern.

The comparing unit 3 compares the determined contextual pattern with the retrieved help information and selects a subset of help information from the retrieved help information based on a result of the comparison. Thus, only help information that may be relevant to the user is selected.

The display unit 4 continuously displays the subset of help information to the user. The display unit 4 may display the subset within a graphical user interface of the program shown on a monitor (not shown). The subset of help information provides context-sensitive help for the actual status of the program. Thus, help information that may be relevant to the user for his actual actions within the program is shown.

To improve the selection of the help information, the evaluation unit 5 may receive a user input indicating an evaluation of the displayed subset of help information. The evaluation may indicate whether the shown subset of help information is relevant or useful or not.

The communication unit 6 may receive a question from the user and forward the question to the at least one external source 20. Further, the communication unit 6 may receive a question from the at least one external source 20 and display the question to the user. In addition (or alternatively), the communication unit 6 may receive an answer from the user to a displayed question and forward the answer to the at least one external source 20. Thus, the user may communicate with the external source 20 via the program.

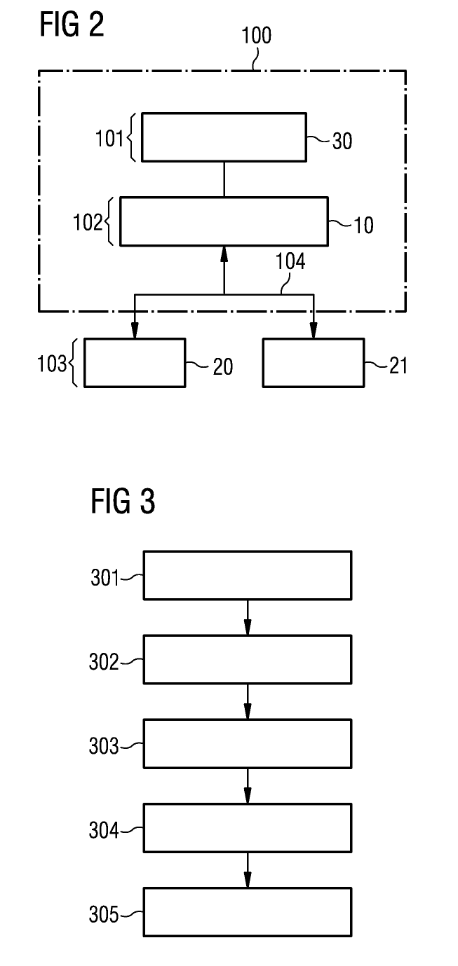

FIG. 2 shows a computer system 100. The computer system 100 includes an application unit 30, the device 10 of FIG. 1, and a communication interface 104. The computer system 100 and/or the device 10 may include one or more processors and one or more non-transitory memories. Stored in the memory(ies) are instructions to configure the processor(s) to implement the program, the units of the device 10, and/or other units of the computer system 100. The memory(ies) may also store data indicative of the contextual pattern of the program and the help information retrieved from the external source(s).

The application unit 30 runs or executes the program, also called software tool, to be used by a user. During execution or runtime of the program, the device 10 provides context-sensitive help to the user.

To provide the context-sensitive help, the device 10 communicates with at least one external source 20, 21 via the communication interface. According to this embodiment, there are two external sources 20, 21. There may be also more or less external sources.

The application unit 30 may be assigned to an application layer 101, the device 10 may be assigned to a contextual intelligence middleware layer 102, and the external sources 20, 21 may be assigned to a community layer 103.

The application unit 30 may execute for example a CAD tool. If the user uses the tool, the working context is determined by the device 10. Due to the analysis of the context patterns and the comparison with the contents of the external sources 20, 21, the device 10 provides a typical question and the corresponding answer, which are part of one external source 20, 21, to the application unit 30 and displays the question and answer to the user.

The application unit 30 may also execute a development tool, for example a software development tool or project planning tool.

For the case of a project planning tool, the different modules to be combined may have physical quantities or other properties, such as electrical properties. This information may be used for providing context-sensitive help that may show for example a selection of suitable transformers or the like.

For the case of a software development tool, the available context information may be a programming language, used libraries (for the whole project or for the current file), API calls, etc. This information may be used for providing context-sensitive help.

FIG. 3 illustrates a method for providing context-sensitive help for a user when using a program. The method includes the following acts 301 to 305. The method is computer-implemented. For example, one or more acts of the method may be implemented by the device 10 (FIG. 1), the computer system 100 (FIG. 2), and/or one or more processors thereof.

In a first act 301, a contextual pattern of an actual status of the program is continuously determined.

In a second act 302, help information is retrieved from at least one external source 20 based on the determined contextual pattern.

In a third act 303, the determined contextual pattern is compared with the retrieved help information.

In a fourth act 304, a subset of help information is selected from the retrieved help information based on a result of the comparison.

In a fourth act 305, the subset of help information is continuously displayed to the user, the subset of help information providing context-sensitive help for the actual status of the program.

It should be noted that the acts of the method of FIG. 3 may be rearranged in their order and/or that some acts may be executed parallel to each other.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications may be made to the described embodiments. It is therefore intended that the foregoing description be regarded as illustrative rather than limiting, and that it be understood that all equivalents and/or combinations of embodiments are intended to be included in this description.

1. A device for providing context-sensitive help for a user when using a program, the device comprising:
a determination unit configured to determine continuously a contextual pattern of an actual status of the program;
a retrieving unit configured to retrieve help information from at least one external source based on the determined contextual pattern;
a comparing unit configured to compare the determined contextual pattern with the retrieved help information and configured to select a subset of help information from the retrieved help information based on a result of the comparison; and
a display unit configured to display continuously the subset of help information to the user, the subset of help information providing the context-sensitive help for the actual status of the program.

2. The device according to claim 1, wherein the determination unit is configured to determine the contextual pattern by determining statistic metadata of the program and a program history.

3. The device according to claim 2, wherein the statistic metadata includes at least one of a version of the program, a configuration of the program, a used hardware, and an operating system.

4. The device according to claim 2, wherein the program history includes at least one of activated functions, selected views, and activated files.

5. The device according to claim 2, wherein the determination unit is configured to determine the contextual pattern by determining an intention of the user based on the program history.

6. The device according to claim 1, wherein the at least one external source is a dedicated forum, an independent forum, or both the dedicated forum and the independent forum.

7. The device according to claim 1, wherein the comparing unit is configured to analyze contents of the at least one external source for generating context information of the analyzed contents.

8. The device according to claim 7, wherein the comparing unit is configured to compare the contextual pattern and the generated context information.

9. The device according to claim 1, wherein the comparing unit is configured to select the subset of help information by applying a threshold to the result of the comparison.

10. The device according to claim 1, further comprising an evaluation unit configured to receive a user input indicating an evaluation of the displayed subset of help information.

11. The device according to claim 1, further comprising a communication unit configured to receive a question from the user and forward the question to the at least one external source, to receive a question from the at least one external source and display the question to the user, to receive an answer from the user to a displayed question and forward the answer to the at least one external source, or any combination thereof.

12. A computer system comprising:
an application unit configured to execute a program to be used by a user;
a communication interface configured to communicate with at least one external source; and
a device configured to provide context-sensitive help for the user when using the program by communicating with the at least one external source, the device comprising:
a determination unit configured to determine continuously a contextual pattern of an actual status of the program;
a retrieving unit configured to retrieve help information from at least one external source based on the determined contextual pattern;
a comparing unit configured to compare the determined contextual pattern with the retrieved help information and configured to select a subset of help information from the retrieved help information based on a result of the comparison; and
a display unit configured to display continuously the subset of help information to the user, the subset of help information providing the context-sensitive help for the actual status of the program.

13. The computer system according to claim 12, wherein the application unit is configured to integrate the context-sensitive help into the program.

14. A method for providing a context-sensitive help for a user when using a program, the method comprising:
determining continuously a contextual pattern of an actual status of the program;
retrieving help information from at least one external source based on the determined contextual pattern;
comparing the determined contextual pattern with the retrieved help information;
selecting a subset of help information from the retrieved help information based on a result of the comparison; and
displaying continuously the subset of help information to the user, the subset of help information providing the context-sensitive help for the actual status of the program.

15. A computer program product comprising program code stored on a non-transitory memory, the program code configuring a processor to execute a method for providing context-sensitive help for a user when using a program run on at least one computer, the method comprising:
determining continuously a contextual pattern of an actual status of the program;
retrieving help information from at least one external source based on the determined contextual pattern;
comparing the determined contextual pattern with the retrieved help information;
selecting a subset of help information from the retrieved help information based on a result of the comparison; and
displaying continuously the subset of help information to the user, the subset of help information providing the context-sensitive help for the actual status of the program.
